(19) United States
(12) Patent Application Publication
(10) Pub. No.: US 2026/0281937 A1
(43) Pub. Date: Sep. 17, 2026

(54) ENHANCED DATA PRIVACY ASSOCIATION IDENTIFIER-LIST HANDLING ON LONG POWER-SAVE SCENARIOS

(71) Applicant: Cisco Technology, Inc., San Jose, CA (US)

(72) Inventors: Javier Contreras, Barcelona (ES); Domenico Ficara, Essertines-sur-Yverdon (CH); Federico Lovison, Fontanelle (IT); Jerome Henry, Pittsboro, NC (US)

(73) Assignee: Cisco Technology, Inc., San Jose, CA (US)

(21) Appl. No.: 19/450,368

(22) Filed: Jan. 15, 2026

Related U.S. Application Data
(60) Provisional application No. 63/745,763, filed on Jan. 15, 2025.
(60) Provisional application No. 63/776,693, filed on Mar. 24, 2025.
(60) Provisional application No. 63/843,790, filed on Jul. 14, 2025.

(51) Int. Cl. H04W 60/04; H04W 12/02; H04W 52/02

(52) U.S. Cl. CPC H04W 60/04; H04W 12/02; H04W 52/0274

(57) ABSTRACT

Enhanced Data Privacy (EDP) Association Identifier (AID)-list handling on long power-save scenarios may be provided. A non-access point (AP) multi-link device (MLD) establishes an association with an AP MLD, including receiving an indication of assignment to an epoch group for rotation of frame anonymization parameters at an epoch interval and a list of AIDs to be used in corresponding epochs associated with the epoch group. The maintained association includes rotating frame anonymization parameters at epoch intervals using each AID in the list of AIDs during its corresponding epoch. The non-AP MLD enters a sleep state of a power save mode of operation during the association. Upon entering a wake state, the non-AP MLD determines whether it has a valid AID for a then-current epoch. Responsive to not having the valid AID, the non-AP MLD transmits an AID Assignment Response frame indicating a request for a second list of AIDs.

### RELATED APPLICATION

Under provisions of 35 U.S.C. § 119(e), Applicant claims the benefit of and priority to U.S. Provisional Application No. 63/745,763, filed Jan. 15, 2025, U.S. Provisional Application No. 63/776,692, filed Mar. 24, 2025, and U.S. Provisional Application No. 63/843790, filed Jul. 14, 2025, the disclosures of which are incorporated herein by reference in their entirety.

### TECHNICAL FIELD

The present disclosure relates generally to providing Enhanced Data Privacy Association Identifier-list handling on long power-save scenarios.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Enhanced Data Privacy (EDP) Association Identifier (AID)-list handling on long power-save scenarios in accordance with aspects of the present disclosure.

FIG. 2 is a block diagram illustrating an example (re)association response frame in accordance with aspects of the present disclosure.

FIG. 3 is a block diagram illustrating an example EDP Group Parameter frame in accordance with aspects of the present disclosure.

FIG. 4 is a block diagram illustrating an example management frame with a traffic indication map (TIM) element for EDP AID-list handling in accordance with aspects of the present disclosure.

FIG. 5 is a block diagram illustrating an example AID Assignment Response frame in accordance with aspects of the present disclosure.

FIG. 6 is a block diagram illustrating an example AID Assignment Request frame in accordance with aspects of the present disclosure.

FIG. 7 is a flow chart of a method for EDP AID-list handling by a non-AP MLD in accordance with aspects of the present disclosure.

FIG. 8 is a flow chart of a method for EDP AID-list handling by an AP MLD in accordance with aspects of the present disclosure.

FIG. 9 is a block diagram of a computing device in accordance with aspects of the present disclosure.

FIG. 10 is a block diagram of a communications device in accordance with aspects of the present disclosure.

### DETAILED DESCRIPTION

### Overview

Enhanced Data Privacy (EDP) Association Identifier (AID)-list handling on long power-save scenarios may be provided. EDP AID-list handling on long power-save scenarios can include Establishing, by a non-access point (AP) multi-link device (MLD), an association with an AP MLD, including receiving an indication of assignment to an epoch group for rotation of frame anonymization parameters at an epoch interval and a list of AIDs for the non-AP MLD, each of the AIDs to be used in corresponding epochs associated with the epoch group. The non-AP MLD maintains the association with the AP MLD including rotating frame anonymization parameters at epoch intervals using each AID in the list of AIDs during its corresponding epoch. The non-AP MLD enters a sleep state of a power save mode of operation during the association. Upon entering a wake state from the sleep state during the association, the non-AP MLD determines whether it has a valid AID for a then-current epoch. Responsive to not having the valid AID for the then-current epoch, the non-AP MLD transmits an AID Assignment Response frame indicating a request for a second list of AIDs.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Third parties observing the wireless medium may seek to track device locations and activity. To reduce such tracking risks, a Station (STA) implementing Enhanced Data Privacy (EDP) features as described in the Institute of Electrical and Electronics Engineers (IEEE) 802.11bi amendment to the 802.11 standard limits the information the STA discloses. EDP features may also be referred to as Enhanced Privacy Protection (EPP) features. Therefore, reference to EDP as used herein should be understood to correspond to EPP features described in 802.11bi and elsewhere.

Frame anonymization (FA) is an EDP client privacy enhancement feature available when multi-link operation (MLO) is supported. FA targets unencrypted fields and elements that enable presence monitoring of a non-access point (AP) multi-link device (MLD), including the Association Identifier (AID), values derived from the AID, Address 1 on the downlink, Address 2 on the uplink, the Sequence Number (SN), and the Packet Number (PN).

To further improve user privacy, a network can shorten presence monitoring time windows. FA enables restricting these windows, referred to as EDP epochs, to portions of a single association without requiring the STA to leave IEEE 802.11bi State 4 (an authenticated and associated state with the IEEE 802.1X controlled port unblocked for class 1, 2, and 3 frames). For each new EDP epoch, the AP MLD and non-AP MLD establish a new FA parameter set. During an epoch, the AP MLD schedules sequences that anonymize selected over-the-air (OTA) fields of individually addressed frames, including the STA MAC address, AID, PN, and SN. The non-AP MLD rotates visible Media Access Control (MAC) parameters at epoch boundaries, including its visible MAC address and AID, which the non-AP MLD draws from a pool (e.g., a list) that the AP MLD allocates to the non-AP MLD.

Basic Service Set (BSS) Max idle period management enables an AP to indicate a time period (e.g., BSS Max idle period) during which the AP does not disassociate a STA due to non-reception of frames. This feature allows a STA to remain in sleep mode without listening for every beacon and transmitting null frames solely to signal continued presence in the BSS, thereby reducing power consumption. Battery-operated devices particularly benefit from this feature. In example implementations, the max idle period can be over sixteen minutes.

A conflict arises when a deployment uses both FA and a long BSS Max Idle Period. The AP MLD generates a list of AIDs covering multiple future epochs, but if the BSS Max Idle Period is sufficiently long, the non-AP MLD can sleep beyond the AID storage period (the cumulative duration of epochs covered by its AID-list). In this scenario, the non-AP MLD wakes with a valid MAC address, valid association, and valid key material, but without a usable AID. Without a usable AID, the non-AP MLD cannot properly communicate with the AP MLD or other STAs in the BSS. For example, the non-AP MLD cannot transmit data frames that require authentication and association (e.g., class 4 frames). Moreover, the AP MLD cannot use conventional buffered traffic indication mechanisms, such as setting the non-AP MLD's AID in the Traffic Indication Map (TIM) element of Beacon frames. Conventional approaches would require reauthentication or reassociation, which interrupts connectivity and degrades user experience. This can include forcing the non-AP MLD to leave State 4, triggering renegotiation of parameters, and potentially resulting in loss of buffered traffic at the AP MLD.

The systems and methods described herein address this problem by enabling non-AP MLDs that sleep beyond the AID storage period to remain associated and authenticated while transitioning smoothly to an active state. Rather than requiring full reauthentication or parameter renegotiation, the disclosed techniques provide mechanisms for the non-AP MLD to signal its lack of a valid AID and for the AP MLD to provide a new AID-list, thereby preserving the association and enabling seamless resumption of communications. Some embodiments provide configurable AID retention policies that enable an AP MLD to retain or flush AID assignments based on deployment scenarios (e.g., home networks versus public venues). Other embodiments provide signaling mechanisms that enable a non-AP MLD to request a new AID-list upon waking without a valid AID, including using an AID Assignment Response frame with a “no assigned AID” status code indicating the lack of assigned AIDs. Still other embodiments provide default AID mechanisms that enable buffered traffic indication and limited communication for non-AP MLDs lacking valid AIDs. These approaches preserve the association, avoid full reauthentication, and enable seamless resumption of communications.

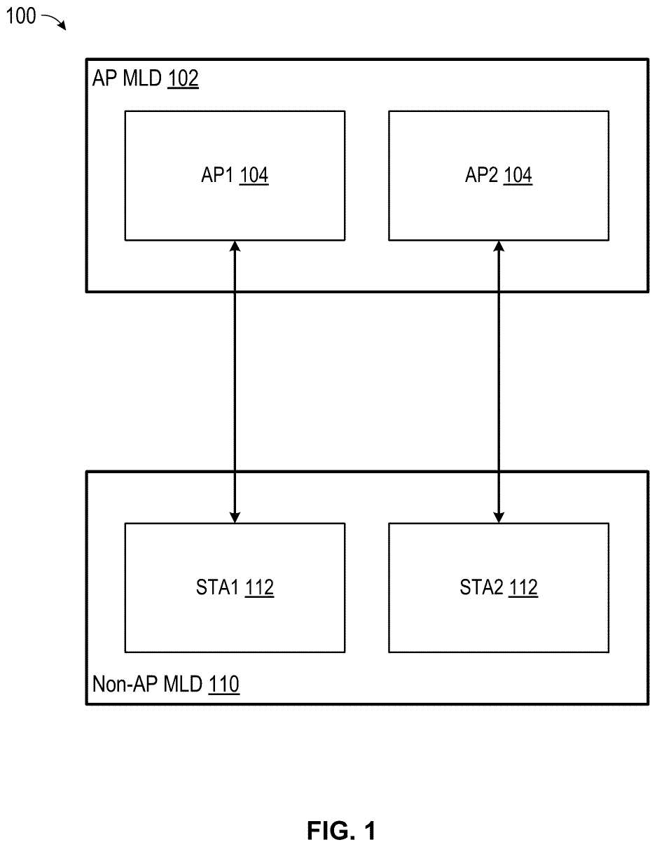

FIG. 1 is a block diagram of an operating environment 100 for EDP AID-list handling on long power-save scenarios. The operating environment 100 includes an AP MLD 102. The AP MLD 102 includes two affiliated APs 104, illustrated as AP1 104 and AP2 104. The operating environment 100 also includes a non-AP MLD 110. The non-AP MLD 110 includes two affiliated STAs 112, illustrated as the STA1 112 and the STA2 112. The AP MLD 102 can include a different number of affiliated APs 104 and/or the non-AP MLD 110 can include a different number of affiliated STAs 112 in other embodiments. Additionally, the operating environment 100 can include additional devices, such as additional non-AP MLDs 110 in the same BSS of the AP MLD 102.

The AP MLD 102 and the non-AP MLD 110 can include processing circuitry, memory, and one or more wireless interfaces for communicating over one or more wireless links. The affiliated AP 104 and STAs 112 operate on respective wireless links and coordinate through their respective MLDs to provide multi-link operation. The wireless links can operate on different frequency bands or channels to provide increased throughput, improved reliability, and enhanced privacy through FA across multiple links.

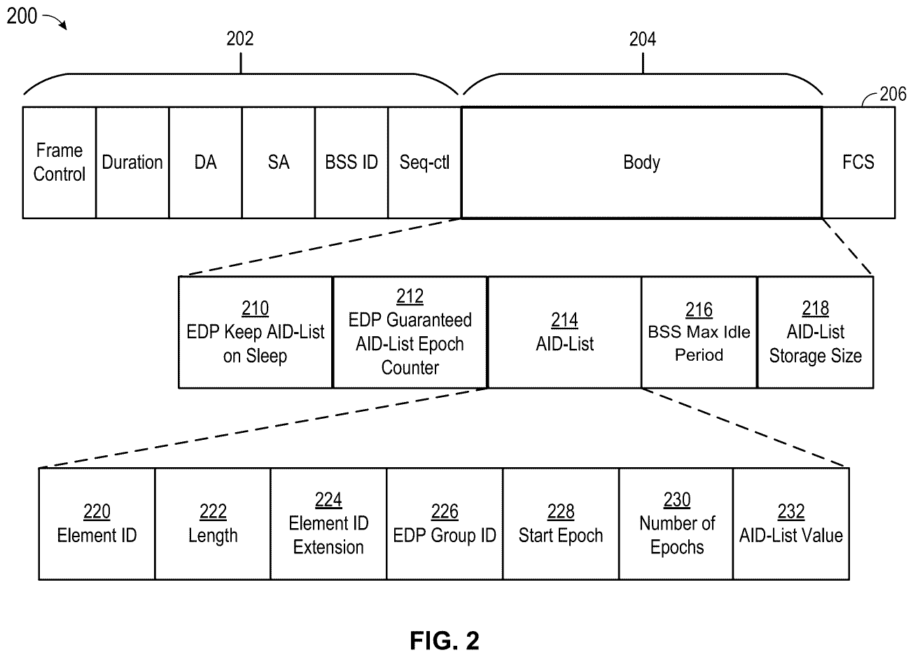

The AP MLD 102 and the non-AP MLD 110 can utilize EDP features for enabling the non-AP MLD 110 to sleep beyond the AID storage period and remain associated and authenticated. The non-AP MLD 110 can therefore transition smoothly to an active state without performing a full reauthentication or parameter renegotiation. The AP MLD 102, for example, can indicate the BSS Max idle period, indicate the handling mode of AID and other EDP parameters (such as via an EDP keep AID-list on sleep parameter or an EDP guaranteed AID-list epoch counter), generate and transmit the list of AIDs for the non-AP MLD 110, indicate buffered traffic for the non-AP MLD 110 (including via a default AID mechanism when the non-AP MLD 110 lacks a valid AID), and receive requests for new AID-lists from the non-AP MLD 110. The AP MLD 102 can communicate this information through various frame types, including (re)association response frames, EDP Group Parameter Frames, AID assignment request frames, and management frames containing TIM elements, as described in greater detail with reference to FIGS. 2-5.

The non-AP MLD 110, upon waking from a sleep state without a valid AID for the current epoch, can transmit an AID Assignment Response frame to the AP MLD 102 to request a new AID-list. This AID Assignment Response frame can include a “no assigned AID” status code indicating that the non-AP MLD 110 has no assigned AIDs. The non-AP MLD 110 can also monitor for buffered traffic indications from the AP MLD 102, including indications via a default AID in TIM elements when the non-AP MLD 110 lacks a valid AID. During normal operation with valid AIDs, the non-AP MLD 110 rotates frame anonymization parameters at epoch boundaries, using each AID from its assigned AID-list during the corresponding epoch.

The AP MLD 102 can organize non-AP MLDs 110 into one or more EDP groups. An EDP group is a collection of non-AP MLDs 110 that share synchronized epoch parameters, including epoch duration and epoch transition times. At any given time, a non-AP MLD 110 can be a member of only one EDP group. The AP MLD 102 can create multiple EDP groups with different epoch settings to accommodate non-AP MLDs 110 with varying capabilities and power consumption requirements. For example, battery-constrained devices may join an EDP group with longer epoch durations to reduce the frequency of epoch transitions and associated processing overhead, while devices with less stringent power constraints may join an EDP group with shorter epoch durations to enhance privacy through more frequent rotation of anonymization parameters. During association, the non-AP MLD 110 can request assignment to an EDP group by indicating its preferred epoch parameters and minimum supported epoch interval length. The AP MLD 102 assigns the non-AP MLD 110 to an EDP group that matches the requested parameters or assigns it to a default EDP group. After association, the non-AP MLD 110 can request to join a different EDP group, and the AP MLD 102 can request that associated non-AP MLDs 110 transition between EDP groups to reorganize group membership. The AP MLD 102 communicates EDP group parameters through EDP Group Parameter frames, which can convey the epoch settings for one or more EDP groups to associated non-AP MLDs 110.

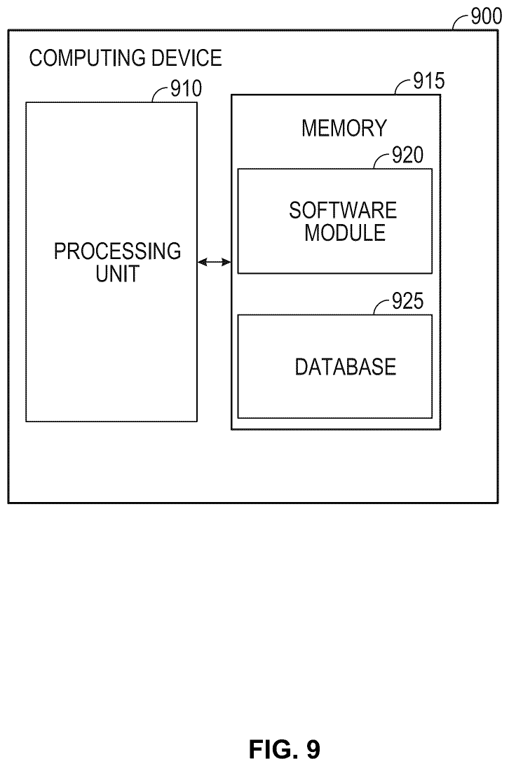

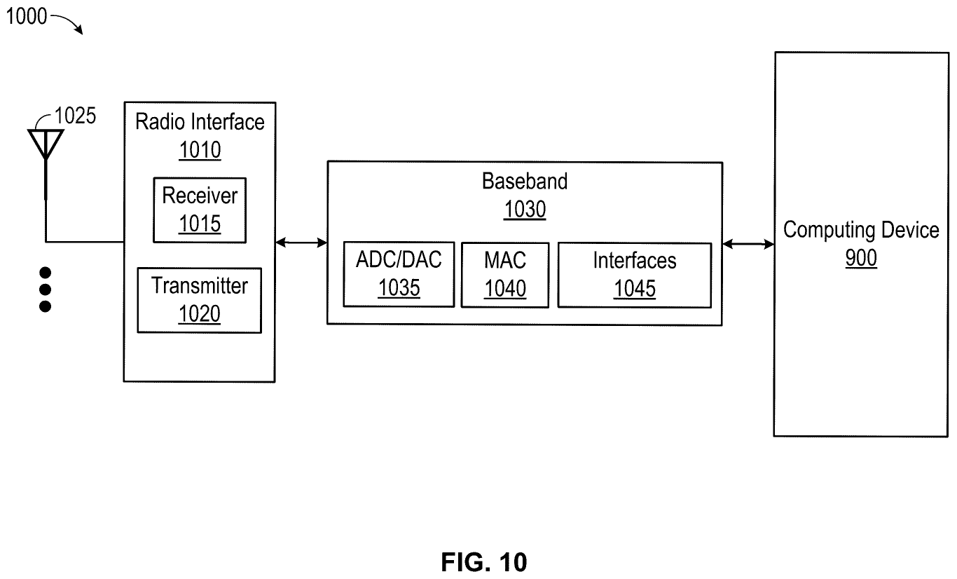

The elements described above of the operating environment 100 (e.g., the AP MLD 102, the APs 104, the non-AP MLD 110, the STAs 112, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 9 and 10, the elements of the operating environment 100 may be practiced in a computing device 900 and/or communications device 1000.

FIG. 2 is a block diagram illustrating an example (re)association response frame 200. The (re)association response frame 200 includes a header 202, a body 204, and a frame check sequence (FCS) field 206. The body 204 includes an EDP keep AID-list on sleep field 210, an EDP guaranteed AID-list epoch counter field 212, an AID-list element 214, a BSS Max idle period field 216 and an AID-list storage size field 218, among other fields and/or elements. When these settings are included in the (re)association response frame 200, they establish BSS-wide policies applicable to all non-AP MLDs 110 regardless of their individual EDP group membership.

The BSS Max idle period field 216 indicates a time period during which the AP MLD 102 will not disassociate the non-AP MLD 110 due to non-reception of frames. This enables the non-AP MLD 110 to remain in sleep mode for extended periods (potentially exceeding sixteen minutes) without transmitting null frames solely to maintain the association. The extended sleep capability, when combined with EDP features, creates the scenario where the non-AP MLD 110 may sleep beyond its AID storage period.

The EDP keep AID-list on sleep field 210 indicates whether the AP MLD 102 maintains the AID-list assigned to the non-AP MLD 110 when it enters sleep mode. In some embodiments, the EDP keep AID-list on sleep field 210 is a bit in a Capability Information field. When this field indicates the AID-list will be maintained during sleep (e.g., set to 1), the AP MLD 102 preserves the AID assignment for the remaining epochs covered by the most recent AID-list negotiation. Once the last assigned epoch expires, the AP MLD 102 does not assign additional AIDs or EDP parameters until the non-AP MLD 110 wakes. The non-AP MLD 110 may request a new parameter set upon waking, but if the last assigned parameters remain valid, the non-AP MLD 110 can use them immediately. During this period, the AP MLD 102 maintains the association as active.

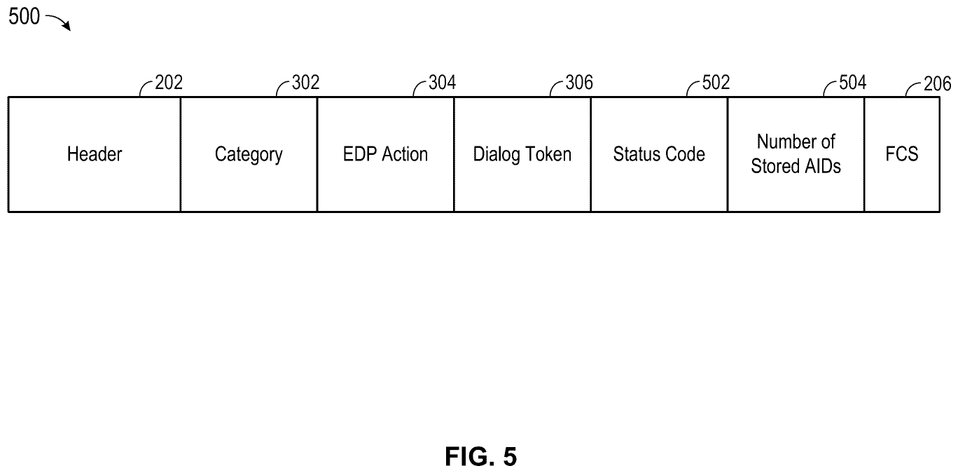

When this field indicates the AID-list will not be maintained during sleep (e.g., set to 0), the AP MLD 102 releases the AID-list at the end of the current epoch when the non-AP MLD 110 enters sleep. In this configuration, the non-AP MLD 110 transmits an AID Assignment Response frame (described with reference to FIG. 5) to obtain a new AID-list whenever it wakes, even if the original AID-list would still be valid.

The EDP guaranteed AID-list epoch counter field 212 indicates the maximum number of epochs for which the AP MLD 102 preserves the AID-list after the non-AP MLD 110 enters sleep before flushing the AID-list. In some embodiments, this counter is expressed as a percentage of the value in the AID-list storage size field 218. In certain embodiments, the AP MLD 102 enforces a minimum sleep timer that specifies a minimum sleep duration before the AID-list flush countdown begins. This prevents the AP MLD 102 from immediately starting the countdown when the non-AP MLD 110 briefly enters sleep, improving efficiency by avoiding unnecessary AID flushing for short sleep periods.

Setting the EDP guaranteed AID-list epoch counter field 212 enables the AP MLD 102 to implement different AID retention policies for different deployment scenarios. For example, in a small network use case (e.g., a residential wireless network) with no AID availability constraints, the AP MLD 102 can preserve the full AID-list while the non-AP MLD 110 sleeps to prioritize quick recovery when waking. In a large network use case (e.g., a public venue wireless network) where the AP MLD 102 seeks to maximize AID reuse, the AP MLD 102 can flush AIDs soon after the non-AP MLD 110 enters sleep. The AP MLD 102 maintains the AID-list for at most the number of epochs specified by the counter in the EDP guaranteed AID-list epoch counter field 212.

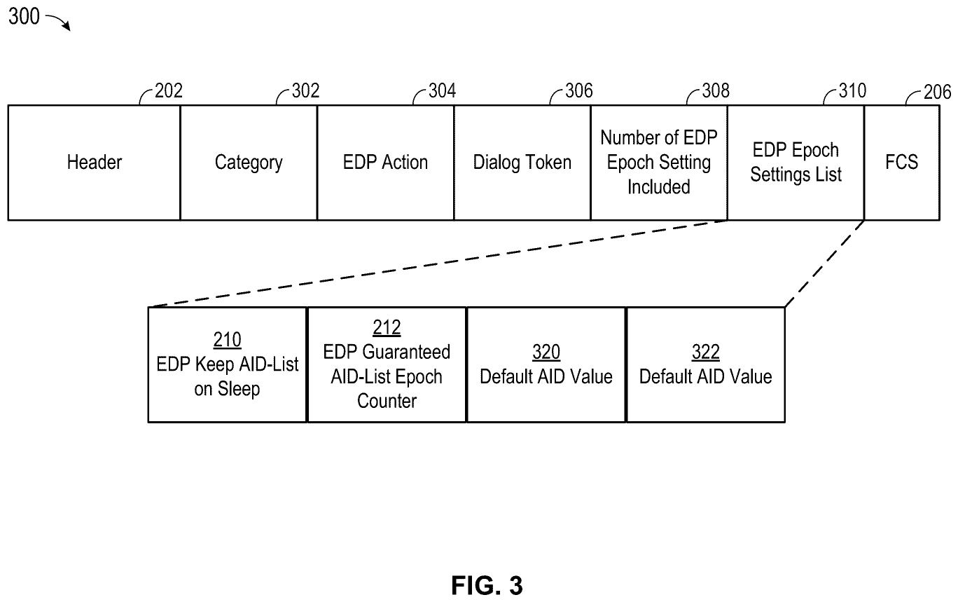

In some embodiments, the AP MLD 102 dynamically modifies the EDP keep AID-list on sleep field 210 and/or the EDP guaranteed AID-list epoch counter field 212 by advertising updated values in periodic EDP Group Parameter frames (described with reference to FIG. 3). This dynamic modification enables the AP MLD 102 to adjust the AID-list retention policy based on current or predicted AP load, preserving more AIDs during sleep when lightly loaded and freeing AIDs more quickly under higher load conditions.

The AID-list element 214 includes an element ID field 220, a length field 222, an element ID extension field 224, an EDP group ID field 226, a start epoch field 228, a number of epochs field 230, and an AID-list value field 232. The start epoch field 228 contains the two least significant octets of the EDP epoch corresponding to the first AID in the AID-list value field 232. The number of epochs field 230 indicates the number of consecutive epochs for which AIDs are provided in the AID-list value field 232. The AID-list value field 232 contains the AID-list and, optionally, padding to align the field to octet limits. The AID-list comprises an amount of AID fields equal to the value in the number of epochs field 230. In example implementations, each AID field is twelve bits and indicates the twelve least significant bits of an AID assigned to an epoch. In other implementations, the AID fields are sixteen bits.

In some embodiments, the non-AP MLD 110 advertises a sleep period via target wake time (TWT) parameters. Based on the announced TWT parameters, the AP MLD 102 may proactively provide an updated AID-list for the non-AP MLD 110 to use upon waking and may flush the current AID-list immediately when the non-AP MLD 110 enters sleep.

FIG. 3 is a block diagram illustrating an example EDP Group Parameter frame 300. The EDP Group Parameter frame 300 includes a Category field 302, an EDP Action field 304, a dialog token field 306, a number of EDP epoch settings included field 308, and an EDP epoch settings list field 310. The EDP Group Parameter frame 300 is used to carry EDP epoch settings for one or more EDP groups and enables the AP MLD 102 to communicate group-specific parameters to associated non-AP MLDs 110.

The Category field 302 has a value indicating the category of action frame. The Category field 302 can indicate the frame is an EDP frame in example implementations. The EDP Action field 304 has a value distinguishing the EDP Group Parameter frame 300 from other EDP frame types, such as capabilities and operation parameters request frames, capabilities and operation parameters response frames, EDP epoch request frames, EDP epoch response frames, AID Assignment Request frames, and AID Assignment Response frames. The dialog token field 306 includes a unique nonzero value for identifying frame exchanges.

The number of EDP epoch settings included field 308 specifies the number of EDP epoch settings fields that are in the EDP epoch settings list field 310. The EDP epoch settings list field 310 contains one or more EDP setting fields indicating the parameters of EDP groups that the AP MLD 102 wants to convey to associated non-AP MLDs 110.

The AP MLD 102 can use the EDP Group Parameter frame 300 for various operations. In some embodiments, the AP MLD 102 advertises the EDP keep AID-list on sleep field 210 and/or the EDP guaranteed AID-list epoch counter field 212 in the EDP epoch settings list field 310 or elsewhere in the EDP Group Parameter frame 300 rather than in the (re)association response frame 200. This enables the AP MLD 102 to enforce different AID retention policies for each individual EDP group rather than applying a single BSS-wide policy. The AP MLD 102 can dynamically modify these parameters by advertising updated values in periodic EDP Group Parameter frames 300, allowing adjustment of AID-list retention policy based on current or predicted AP load.

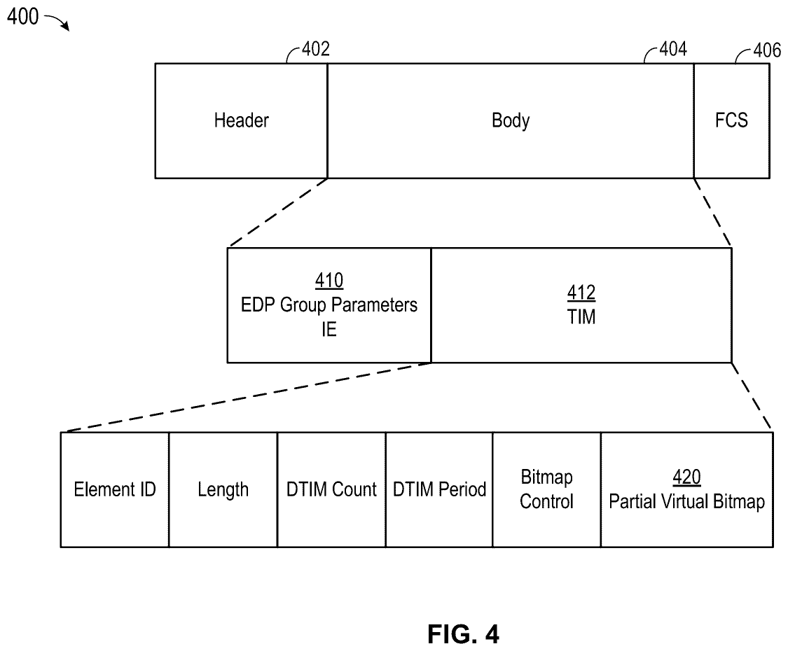

In some embodiments, the EDP Group Parameter frame 300 (e.g., in the EDP epoch settings list field 310) includes a default AID value field 320 and a default AID interval field 322. When non-AP MLDs 110 lack valid AIDs (either because AIDs have expired or been flushed by the AP MLD 102 following the configured EDP keep AID-list on sleep policy), the AP MLD 102 can indicate buffered traffic using a default AID mechanism. The default AID enables the AP MLD 102 to set an AID in the TIM element of management frames (described with reference to FIG. 4) to signal buffered traffic for non-AP MLDs 110 without valid AIDs.

The default AID value can be configured in different ways. In some embodiments, the default AID is fixed and set by the IEEE 802.11 standard from reserved AID ranges. In other embodiments, the default AID is statically configured on a per Extended Service Set (ESS), per BSS, or per EDP group basis. In this case, the specific value is advertised in the default AID value field 320 within the EDP Group Parameter frame 300. In further embodiments, the default AID is dynamically rotated (on a per ESS, per BSS, or per EDP group basis). The default AID interval field 322 indicates the interval at which the default AID value is rotated and the default AID value field 320 is updated. The interval value may be expressed in different formats (such as number of epochs or absolute time) and is configured to be longer (such as two times longer or more) than the BSS Max idle period to ensure all non-AP MLDs 110 can update the known default AID value even after long sleep periods.

In additional embodiments, the AP MLD 102 reserves a pool of AIDs to be allocated as default AIDs, and non-AP MLDs 110 can use the pool in different ways. In one implementation, the AP MLD 102 distributes a set of reserved AIDs in the EDP Group Parameter frame 300, and the non-AP MLD 110 randomly selects from the set. In another implementation, the non-AP MLD 110 computes which default AID to use with a hash function using the non-AP MLD MAC address and the current epoch number as input parameters. In a further embodiment, the AP MLD 102 assigns one or more different default AID values to each non-AP MLD 110. In yet another embodiment, the AP MLD 102 distributes the same pool of default AIDs with different permutations to different non-AP MLDs 110 such that the same AID is not in the same position in the list for each non-AP MLD 110. When a non-AP MLD 110 needs to use a default AID, it uses the AID in the list corresponding to the current epoch number modulo the size of the list it received. This ensures different non-AP MLDs 110 will use different AIDs in the same epoch without requiring the list to be updated at each use.

The default AID parameters can alternatively be advertised in the (re)association response frame 200 for BSS-wide application. When advertised in the EDP Group Parameter frame 300, different EDP groups can have different default AID configurations tailored to their specific operational requirements.

FIG. 4 is a block diagram illustrating an example management frame 400 with a TIM element for EDP AID-list handling. The management frame 400 includes a header 402, a body 404, and an FCS field 406. In the illustrated embodiment, the body 404 includes an EDP Group Parameter information element (IE) 410 and a Traffic Indication Map (TIM) element 412, among other fields and elements. The TIM element 412 includes a partial virtual bitmap 420.

During normal operation, the AP MLD 102 advertises the presence of buffered traffic for sleeping non-AP MLDs 110 by setting their AIDs in the partial virtual bitmap 420 of the TIM element 412. When a non-AP MLD 110 wakes from sleep and monitors Beacon frames (which typically carry TIM elements 412), the non-AP MLD 110 checks whether its current AID is set in the partial virtual bitmap 420. If set, the non-AP MLD 110 knows that the AP MLD 102 has buffered traffic waiting for delivery and can retrieve the buffered traffic using the assigned AID.

When a non-AP MLD 110 sleeps beyond the AID storage period, the non-AP MLD 110 may have no valid EDP parameters including AIDs, either because the AIDs have expired or have been flushed by the AP MLD 102 following the configured EDP keep AID-list on sleep policy. The normal TIM mechanism does not apply to non-AP MLDs 110 without valid AIDs because the AP MLD 102 cannot set a specific AID in the partial virtual bitmap 420 when the non-AP MLD 110 lacks a currently valid AID or when the AID may have been reallocated to a different non-AP MLD.

To address this scenario, the AP MLD 102 can use a default AID mechanism to indicate buffered traffic for non-AP MLDs 110 without valid AIDs. As described with reference to FIG. 3, the default AID value can be configured as a fixed value from reserved AID ranges, statically configured on a per ESS, per BSS, or per EDP group basis, dynamically rotated at specified intervals, or selected from a pool using various allocation methods. The AP MLD 102 sets the default AID in the partial virtual bitmap 420 of the TIM element 412 when there is at least one non-AP MLD 110 that has exhausted its AIDs and there is buffered traffic for at least one of those non-AP MLDs 110.

When a non-AP MLD 110 wakes without a valid AID for the current epoch, the non-AP MLD 110 monitors Beacon frames for the default AID in the TIM element 412. Upon detecting that the default AID is set in the partial virtual bitmap 420, the non-AP MLD 110 determines that buffered traffic exists (though not necessarily for itself, as the default AID may indicate buffered traffic for any non-AP MLD 110 without a valid AID). The non-AP MLD 110 then transmits an AID Assignment Response frame (described with reference to FIG. 5) with a status code indicating no assigned AID to request a new AID-list. In some embodiments, the non-AP MLD 110 assumes the use of the applicable default AID value when transmitting the AID Assignment Response frame.

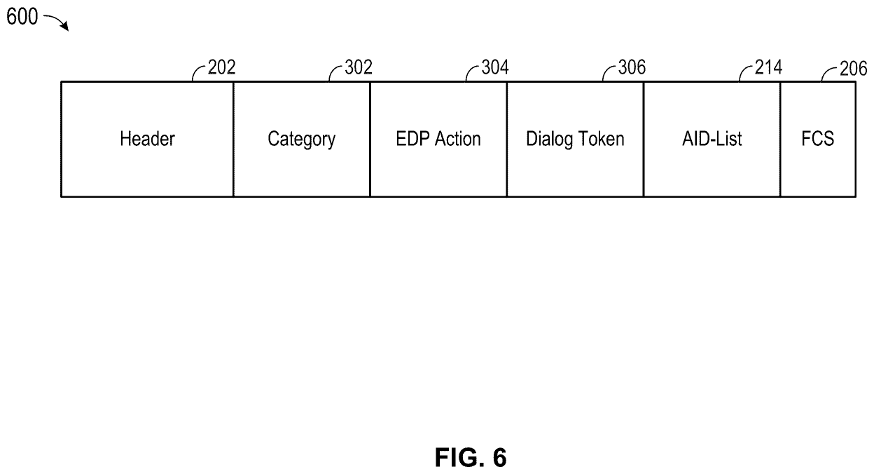

In alternative embodiments, the non-AP MLD 110 can transmit a PS-Poll frame, QoS null frame, or trigger frame using the current over-the-air MAC address as the transmitter address and the default AID to signal the “no assigned AID” status. Upon receiving such a frame, the AP MLD 102 responds with an updated AID-list via an AID Assignment Request frame (described with reference to FIG. 6). If buffered traffic exists for the specific non-AP MLD 110, the AP MLD 102 sets the “more data” bit to 1 in the AID Assignment Request frame, and the non-AP MLD 110 requests delivery of the buffered traffic using a newly assigned AID from the updated AID-list. If no buffered traffic exists for that specific non-AP MLD 110, the AP MLD 102 responds with the new AID-list and sets the “more data” bit to 0. In a further embodiment, the non-AP MLD 110 transmits a QoS data frame with padding or random payload instead of an unprotected QoS null frame to provide protection against spoofing attacks.

The non-AP MLD 110 that lacks a valid AID for the current epoch shall refrain from transmitting class 4 frames (authenticated and associated data frames) until new EDP parameters including a valid AID-list have been assigned. The non-AP MLD 110 is limited to transmitting AID Assignment Response frames, disassociation frames, deauthentication frames, and control frames until it receives a new AID-list. If the non-AP MLD 110 transmits other traffic without obtaining fresh EDP parameters, the AP MLD 102 shall disassociate the non-AP MLD 110 with a status code indicating no assigned AID.

FIG. 5 is a block diagram illustrating an example AID Assignment Response frame 500. The AID Assignment Response frame 500 includes a Category field 302, an EDP Action field 304, a dialog token field 306, a status code field 502, and a number of stored AIDs field 504. The AID Assignment Response frame 500 is transmitted by the non-AP MLD 110 to the AP MLD 102 when the non-AP MLD 110 wakes without a valid AID for the current or next epoch and requests a new AID-list.

The status code field 502 includes a value to indicate a status. In certain embodiments, the status code field 502 can indicate a request to join an EDP group epoch is successful, the request to join an EDP group epoch is successful but the requested epoch parameters are not exactly the requested parameters, a failure to create an epoch group, a partial success to store an AID-list, a failure to store an AID-list, and so on.

The non-AP MLD 110 can also indicate that it has no assigned AID for current epoch via the status code field 502. When the non-AP MLD 110 has no valid AID for the current epoch, the Status Code field 502 is set to a “no assigned AID” status. This status code indicates that the non-AP MLD 110 has no AID value for the current group EDP epoch and constitutes a request for a new AID-list. The “no assigned AID” status can occur because the previously assigned AIDs have expired beyond their designated epochs or have been flushed by the AP MLD 102 following the configured EDP keep AID-list on sleep policy.

The number of stored AIDs field 504 is present if the status code field 502 indicates storing the AID-list is successful but only partially stored to indicate the number of AIDs that the non-AP MLD 110 has stored. The number of stored AIDs field 504 may not be present otherwise.

When transmitting the AID Assignment Response frame 500 with the “no assigned AID” status code, the non-AP MLD 110 uses the active MAC address for the present epoch. In some embodiments, the non-AP MLD 110 assumes the use of the applicable default AID value when transmitting the frame. In other embodiments, the non-AP MLD 110 sends the frame with no AID because the previously assigned AIDs are no longer valid and may have been reassigned to other non-AP MLDs by the AP MLD 102.

After transmitting the AID Assignment Response frame 500 with the “no assigned AID” status code, the non-AP MLD 110 sets at least one affiliated STA to active mode and keeps it awake until it receives the new AID-list from the AP MLD 102. The AP MLD 102 assigns new AIDs for the coming EDP epochs and responds by transmitting an AID Assignment Request frame (described with reference to FIG. 6) containing the new AID-list.

In some embodiments, the non-AP MLD 110 sends a reassociation request to obtain new AIDs. The AP MLD 102 provides the AIDs for the current and following epochs in the (re)association response frame 200, allowing the non-AP MLD 110 to refresh all association parameters. However, this option may result in loss of buffered traffic at the AP MLD 102.

In some embodiments, the non-AP MLD 110 remains in power save mode from the perspective of the AP MLD 102 until the AID-list is provided via the AID Assignment Request frame and further acknowledged by the non-AP MLD 110 via an AID Assignment Response frame 500 with a successful status code. This approach ensures the non-AP MLD 110 has a complete configuration including a valid AID-list before data forwarding can occur.

If a non-AP MLD 110 successfully stores an AID-list received in an AID Assignment Request frame, the non-AP MLD 110 may choose not to respond with an AID Assignment Response frame 500, as the successful reception and storage is indicated by the absence of a response.

FIG. 6 is a block diagram illustrating an example AID Assignment Request frame 600. The AID Assignment Request frame 600 includes the Category field 302, the EDP Action field 304, the dialog token field 306, and an AID-list element 214.

The AP MLD 102 transmits the AID Assignment Request frame 600 for subsequent AID assignments after the initial AID-list provided in the (re)association response frame 200. When the non-AP MLD 110 wakes without a valid AID and transmits an AID Assignment Response frame 500 with the “no assigned AID” status code, the AP MLD 102 responds by generating a new list of AIDs and transmitting the AID Assignment Request frame 600 with the new AID-list element 214.

As described above with respect to FIG. 2, the AID-list size indicated by the number of epochs field 230 shall be smaller than or equal to the AID storage size capability indicated by the non-AP MLD 110. While generating the list of AIDs, the AP MLD 102 ensures that at any point in time each non-AP MLD is assigned a unique AID value. The AIDs in the AID-list element 214 are used for communications starting from the epoch indicated in the start epoch field 228, for the number of epochs indicated in the number of epochs field 230.

If the start epoch field 228 indicates an epoch for which an AID has already been assigned, the AIDs in the AID-list shall override the previously assigned AIDs beginning from the epoch number indicated by the start epoch field 228. However, the AID value indicated in the AID field of the (re)association response frame 200 shall not be overridden.

Before the end of all epochs indicated in the number of epochs field 230, the AP MLD 102 generates a new list of AID values and sends a new AID Assignment Request frame 600 to ensure the non-AP MLD 110 has AIDs for upcoming epochs. The AP MLD 102 may also generate and send a new AID-list at any time to update the AID assignments proactively.

When the AID Assignment Request frame 600 is sent in response to an AID Assignment Response frame 500 requesting new AIDs due to buffered traffic indication via the default AID mechanism (described with reference to FIG. 4), the AP MLD 102 sets the “more data” bit in the frame to indicate whether buffered traffic exists for that specific non-AP MLD 110. If buffered traffic exists, the “more data” bit is set to 1, and the non-AP MLD 110 requests delivery of the buffered traffic using a newly assigned AID from the updated AID-list. If no buffered traffic exists for that specific non-AP MLD 110, the “more data” bit is set to 0.

Upon receiving the AID Assignment Request frame 600, if the non-AP MLD 110 successfully stores the entire AID-list, it may choose not to respond with an AID Assignment Response frame, as successful reception and storage is indicated by the absence of a response. If the non-AP MLD 110 has not been able to store every AID in the AID-list, it shall respond with an AID Assignment Response frame 500 with an appropriate status code as described with reference to FIG. 5. Upon AID assignment failure, the AP MLD 102 may repeat the AID assignment operation or may request the non-AP MLD 110 to join a different EDP group.

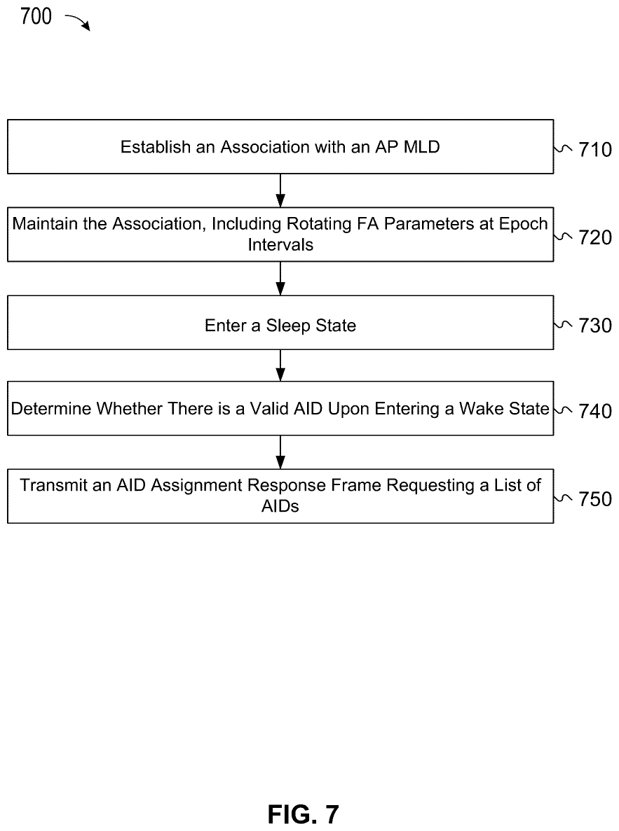

FIG. 7 is a flow chart of a method 700 for EDP AID-list handling by a non-AP MLD 110. The method 700 enables the non-AP MLD to request new AIDs when waking without valid AIDs, avoiding disassociation while maintaining privacy protection through frame anonymization.

At operation 710, the non-AP MLD 110 establishes an association with the AP MLD 102. The establishing comprises receiving an indication of assignment to an epoch group for rotation of FA parameters at an epoch interval and a list of AIDs for the non-AP MLD 110, each of the AIDs to be used in corresponding epochs associated with the epoch group. The AP MLD 102 provides the initial AID-list in the (Re)Association Response frame 200 as described with reference to FIG. 2. In some embodiments, the non-AP MLD 110 receives an indication of a maximum idle period (e.g., BSS Max idle period) from the AP MLD 102. The indication of the maximum idle period may be received in the (Re)Association Response frame 200 transmitted by the AP MLD 102.

At operation 720, the non-AP MLD 110 maintains the association with the AP MLD 102 including rotating FA parameters at epoch intervals using each AID in the list of AIDs during its corresponding epoch. During this phase, the non-AP MLD 110 periodically changes visible MAC parameters at each epoch interval, including the STA MAC address and the visible AID, using at each epoch a new value from the AID-list allocated by the AP MLD 102. The FA parameters are rotated according to the epoch group settings to provide privacy protection for the non-AP MLD 110.

At operation 730, the non-AP MLD 110 enters a sleep state of a power save mode of operation during the association. The sleep state enables extended power save operation for battery-powered devices, allowing the non-AP MLD 110 to conserve power without transmitting frequent keep-alive frames. While in the sleep state, the non-AP MLD 110 may sleep beyond the AID storage period, particularly when the maximum idle period exceeds the AID storage size. In some embodiments, the duration of any sleep state does not exceed the maximum idle period to prevent disassociation. In certain embodiments, the non-AP MLD 110 transmits one or more null frames to the AP MLD 102 prior to expiration of the maximum idle period to signal continuous presence in the BSS and maintain the association.

At operation 740, upon entering a wake state from the sleep state during the association, the non-AP MLD 110 determines whether it has a valid AID for the then-current epoch. The non-AP MLD 110 may lack a valid AID either because the previously assigned AIDs have expired beyond their designated epochs or have been flushed by the AP MLD 102 following the configured EDP keep AID-list on sleep policy. When the non-AP MLD 110 wakes with no valid AID, it may have a valid MAC address, a valid association, and key material, but no usable AID for proper communication with the AP MLD 102 and other devices in the BSS.

At operation 750, responsive to not having a valid AID for the then-current epoch, the non-AP MLD 110 transmits an AID Assignment Response frame 500, the AID Assignment Response frame 500 indicating a request for a second list of AIDs. In some embodiments, the AID Assignment Response frame 500 comprises a “no assigned AID” status code indicating that the non-AP MLD 110 has no assigned AIDs.

The non-AP MLD 110 transmits the AID Assignment Response frame 500 using the active MAC address for the present epoch. After transmitting the AID Assignment Response frame 500, the non-AP MLD 110 sets at least one affiliated STA to active mode and remains awake until it receives the second list of AIDs. The non-AP MLD 110 refrains from transmitting class 4 frames (authenticated and associated data frames) until new EDP parameters including a valid AID-list have been assigned. The non-AP MLD 110 receives from the AP MLD 102 the second list of AIDs in an AID Assignment Request frame 600 (described with reference to FIG. 6), enabling the non-AP MLD 110 to resume normal operations with fresh AIDs for upcoming epochs.

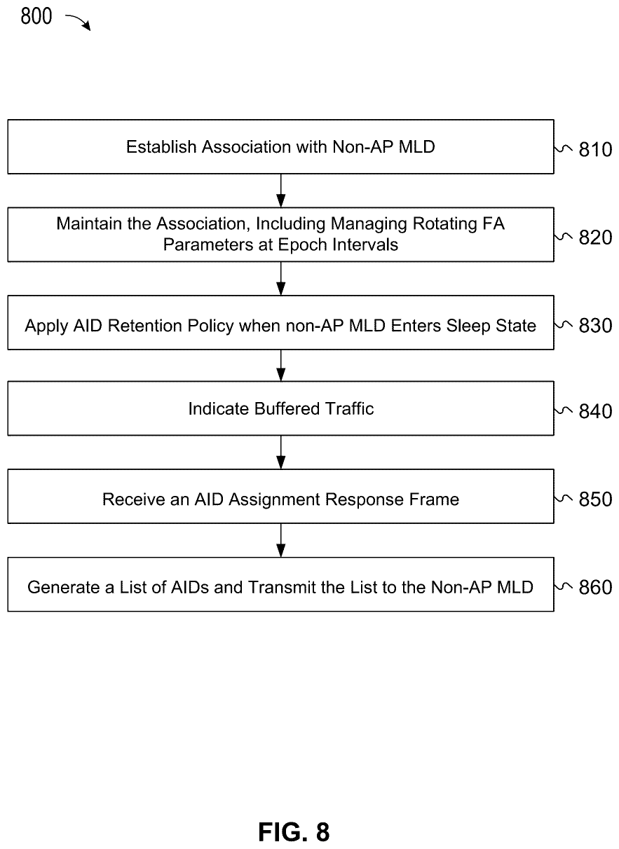

FIG. 8 is a flow chart of a method 800 for EDP AID-list handling by the AP MLD 102. The method 800 enables the AP MLD 102 to maintain associations with non-AP MLDs 110 during extended sleep periods while managing AID allocation efficiently and providing mechanisms for non-AP MLDs 110 to obtain fresh AIDs upon waking without valid AIDs.

At operation 810, the AP MLD 102 establishes an association with the non-AP MLD 110. The establishing comprises assigning the non-AP MLD 110 to an epoch group for rotation of FA parameters at an epoch interval and providing a first list of AID for the non-AP MLD 110, each of the AIDs to be used in corresponding epochs associated with the epoch group. The AP MLD 102 provides the first AID-list in the (re)association response frame 200. The AP MLD 102 generates the list of AIDs ensuring that at any point in time each non-AP MLD is assigned a unique AID value. The AID-list size is smaller than or equal to the AID storage size capability indicated by the non-AP MLD 110. In some embodiments, the AP MLD 102 transmits an indication of a maximum idle period to the non-AP MLD 110 in the (re)association Response frame 200.

At operation 820, the AP MLD 102 maintains the association with the non-AP MLD 110 including managing FA parameters that rotate at epoch intervals, with each AID in the first list of AIDs being used during its corresponding epoch. The AP MLD 102 communicates EDP group parameters through EDP Group Parameter frames 300, which convey epoch settings for one or more EDP groups to associated non-AP MLDs 110. The AP MLD 102 configures AID retention policies through the EDP keep AID-list on sleep field 210 and the EDP guaranteed AID-list epoch counter field 212, either in the (re)association Response frame 200 for BSS-wide application or in EDP Group Parameter frames 300 for group-specific policies. In some embodiments, the AP MLD 102 dynamically modifies these parameters by advertising updated values in periodic EDP Group Parameter frames 300, adjusting AID-list retention policy based on current or predicted AP load.

At operation 830, when the non-AP MLD 110 enters a sleep state, the AP MLD 102 applies the configured AID retention policy. When the EDP keep AID-list on sleep policy indicates that AIDs will be maintained during sleep, the AP MLD 102 preserves the AID assignment for the remaining epochs covered by the most recent AID-list negotiation. Once the last assigned epoch expires, the AP MLD 102 does not assign additional AIDs until the non-AP MLD 110 wakes, though the AP MLD 102 maintains the association as active. When the EDP keep AID-list on sleep policy indicates that AIDs will not be maintained during sleep, the AP MLD 102 releases the AID-list at the end of the current epoch when the non-AP MLD 110 enters sleep. When using the EDP guaranteed AID-list epoch counter, the AP MLD 102 maintains the AID assignment list for at most the number of epochs defined by the counter. In some embodiments, the AP MLD 102 enforces a minimum sleep timer specifying a minimum sleep duration before beginning the AID-list flush countdown, preventing unnecessary AID flushing for brief sleep periods.

At operation 840, when buffered traffic exists for one or more non-AP MLDs 110 without valid AIDs, the AP MLD 102 optionally indicates the presence of buffered traffic using a default AID mechanism. The AP MLD 102 sets the default AID in the partial virtual bitmap 420 of the TIM element 412 in management frames 400 when there is at least one non-AP MLD 110 that has exhausted its AIDs and there is buffered traffic for at least one of those non-AP MLDs 110. The default AID value can be configured as a fixed value from reserved AID ranges, statically configured on a per ESS, per BSS, or per EDP group basis, dynamically rotated at specified intervals, or selected from a pool using various allocation methods.

At operation 850, the AP MLD 102 receives an AID Assignment Response frame 500 from the non-AP MLD 110, the AID Assignment Response frame 500 indicating a request for a second list of AIDs. The AID Assignment Response frame 500 comprises a “no assigned AID” status code indicating that the non-AP MLD 110 has no assigned AIDs. The AP MLD 102 receives the AID Assignment Response frame 500 transmitted using the active MAC address for the present epoch. In alternative embodiments, the AP MLD 102 receives a PS-Poll frame, QoS null frame, or trigger frame using the default AID to signal the “no assigned AID” status, or receives a (re)association request from the non-AP MLD 110 seeking to obtain new AIDs.

At operation 860, responsive to receiving the AID Assignment Response frame 500 with the “no assigned AID” status code, the AP MLD 102 generates a second list of AIDs for the non-AP MLD 110 for upcoming EDP epochs and transmits an AID Assignment Request frame 600 containing the second list of AIDs in the AID-list element 214. The AP MLD 102 ensures that at any point in time each non-AP MLD is assigned a unique AID value while generating the second list of AIDs. When the AID Assignment Request frame 600 is sent in response to a request triggered by buffered traffic indication via the default AID mechanism, the AP MLD 102 sets the “more data” bit to 1 if buffered traffic exists for the specific non-AP MLD 110, enabling the non-AP MLD 110 to request delivery using a newly assigned AID from the updated AID-list. If no buffered traffic exists for that specific non-AP MLD 110, the AP MLD 102 sets the “more data” bit to 0. The AP MLD 102 does not send data frames to the non-AP MLD 110 until the non-AP MLD 110 has a valid AID. If the AP MLD 102 receives a protected individually addressed frame (other than AID Assignment Response, disassociation, deauthentication, or control frames) from the non-AP MLD 110 without a valid AID for the current epoch, the AP MLD 102 disassociates the non-AP MLD 110 with a status code indicating no assigned AID.

FIG. 9 is a block diagram of a computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for EDP AID-list handling with respect to FIGS. 1-8. Computing device 900, for example, may provide an operating environment for the AP MLD 102, the APs 104, the non-AP MLD 110, the STAs 112, and the like. The AP MLD 102, the APs 104, the non-AP MLD 110, the STAs 112, and the like may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 900 on the single integrated circuit (chip).

FIG. 10 illustrates an implementation of a communications device 1000 that may implement one or more of the AP MLD 102, the APs 104, the non-AP MLD 110, the STAs 112, etc. In various implementations, the communications device 1000 may comprise a logic circuit. The logic circuit may include physical circuits to perform operations described for one or more of the AP MLD 102, the APs 104, the non-AP MLD 110, the STAs 112, etc., for example. As shown in FIG. 10, the communications device 1000 may include one or more of, but is not limited to, a radio interface 1010, baseband circuitry 1030, and/or the computing device 900.

The communications device 1000 may implement some or all of the structures and/or operations for the AP MLD 102, the APs 104, the non-AP MLD 110, the STAs 112, etc., storage medium, and logic circuit in a single computing entity, such as entirely within a single device. Alternatively, the communications device 1000 may distribute portions of the structure and/or operations using a distributed system architecture, such as a client station server architecture, a peer-to-peer architecture, a master-slave architecture, etc.

A radio interface 1010, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1010 may include, for example, a receiver 1015 and/or a transmitter 1020. The radio interface 1010 may include bias controls, a crystal oscillator, and/or one or more antennas 1025. In additional or alternative configurations, the radio interface 1010 may use oscillators and/or one or more filters, as desired.

The baseband circuitry 1030 may communicate with the radio interface 1010 to process, receive, and/or transmit signals and may include, for example, an Analog-To-Digital Converter (ADC) for down converting received signals with a Digital-To-Analog Converter (DAC) 1035 for up converting signals for transmission. Further, the baseband circuitry 1030 may include a baseband or Physical layer (PHY) processing circuit for the PHY link layer processing of respective receive/transmit signals. Baseband circuitry 1030 may include, for example, a MAC processing circuit 1040 for MAC/data link layer processing. Baseband circuitry 1030 may include a memory controller for communicating with MAC processing circuit 1040 and/or a computing device 900, for example, via one or more interfaces 1045.

In some configurations, PHY processing circuit may include a frame construction and/or detection module, in combination with additional circuitry such as a buffer memory, to construct and/or deconstruct communication frames. Alternatively or in addition, MAC processing circuit 1040 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
establishing, by a non-access point (AP) multi-link device (MLD), an association with an AP MLD,
wherein the establishing comprises receiving an indication of assignment to an epoch group for rotation of frame anonymization parameters at an epoch interval and a list of association identifiers (AIDs) for the non-AP MLD, each of the AIDs to be used in corresponding epochs associated with the epoch group;
maintaining, by the non-AP MLD, the association with the AP MLD including rotating frame anonymization parameters at epoch intervals using each AID in the list of AIDs during its corresponding epoch;
entering, by the non-AP MLD, a sleep state of a power save mode of operation during the association;
upon entering a wake state from the sleep state during the association, determining whether the non-AP MLD has a valid AID for a then-current epoch; and
responsive to not having the valid AID for the then-current epoch, transmitting, by the non-AP MLD, an AID Assignment Response frame, the AID Assignment Response frame indicating a request for a second list of AIDs.

2. The method of claim 1, further comprising receiving, by the non-AP MLD and from the AP MLD, an indication of a maximum idle period.

3. The method of claim 2, wherein the indication of the maximum idle period is received in an association response transmitted by the AP MLD.

4. The method of claim 2, wherein a duration of the sleep state does not exceed the maximum idle period.

5. The method of claim 2, further comprising transmitting, by the non-AP MLD, one or more null frames to the AP MLD prior to expiration of the maximum idle period.

6. The method of claim 1, wherein the AID Assignment Response frame indicating the request for the second list of AIDs comprises a “no assigned AID” status code indicating that the non-AP MLD has no assigned AIDs.

7. The method of claim 1, further comprising receiving from the AP MLD the second list of AIDs.

8. A non-access point (AP) multi-link device (MLD) comprising:
a memory storage; and
a processing unit, disposed in a first computing device and coupled to the memory storage, wherein the processing unit is operative to perform operations comprising:
establishing, by the non-AP MLD, an association with an AP MLD,
wherein the establishing comprises receiving an indication of assignment to an epoch group for rotation of frame anonymization parameters at an epoch interval and a list of association identifiers (AIDs) for the non-AP MLD, each of the AIDs to be used in corresponding epochs associated with the epoch group;
maintaining, by the non-AP MLD, the association with the AP MLD including rotating frame anonymization parameters at epoch intervals using each AID in the list of AIDs during its corresponding epoch;
entering, by the non-AP MLD, a sleep state of a power save mode of operation during the association;
upon entering a wake state from the sleep state during the association, determining whether the non-AP MLD has a valid AID for a then-current epoch; and
responsive to not having the valid AID for the then-current epoch, transmitting, by the non-AP MLD, an AID Assignment Response frame, the AID Assignment Response frame indicating a request for a second list of AIDs.

9. The non-AP MLD of claim 8, the operations further comprising receiving, by the non-AP MLD and from the AP MLD, an indication of a maximum idle period.

10. The non-AP MLD of claim 9, wherein the indication of the maximum idle period is received in an association response transmitted by the AP MLD.

11. The non-AP MLD of claim 9, wherein a duration of the sleep state does not exceed the maximum idle period.

12. The non-AP MLD of claim 9, the operations further comprising transmitting, by the non-AP MLD, one or more null frames to the AP MLD prior to expiration of the maximum idle period.

13. The non-AP MLD of claim 8, wherein the AID Assignment Response frame indicating the request for the second list of AIDs comprises a “no assigned AID” status code indicating that the non-AP MLD has no assigned AIDs.

14. The non-AP MLD of claim 8, the operations further comprising receiving from the AP MLD the second list of AIDs.

15. A non-transitory computer readable storage medium comprising instructions that when executed configure one or more processors of a non-access point (AP) multi-link device (MLD) to perform operations comprising:
establishing, by the non-AP MLD, an association with an AP MLD,
wherein the establishing comprises receiving an indication of assignment to an epoch group for rotation of frame anonymization parameters at an epoch interval and a list of association identifiers (AIDs) for the non-AP MLD, each of the AIDs to be used in corresponding epochs associated with the epoch group;
maintaining, by the non-AP MLD, the association with the AP MLD including rotating frame anonymization parameters at epoch intervals using each AID in the list of AIDs during its corresponding epoch;
entering, by the non-AP MLD, a sleep state of a power save mode of operation during the association;
upon entering a wake state from the sleep state during the association, determining whether the non-AP MLD has a valid AID for a then-current epoch; and
responsive to not having the valid AID for the then-current epoch, transmitting, by the non-AP MLD, an AID Assignment Response frame, the AID Assignment Response frame indicating a request for a second list of AIDs.

16. The non-transitory computer readable storage medium of claim 15, the operations further comprising receiving, by the non-AP MLD and from the AP MLD, an indication of a maximum idle period.

17. The non-transitory computer readable storage medium of claim 16, wherein the indication of the maximum idle period is received in an association response transmitted by the AP MLD.

18. The non-transitory computer readable storage medium of claim 16, wherein a duration of the sleep state does not exceed the maximum idle period.

19. The non-transitory computer readable storage medium of claim 16, the operations further comprising transmitting, by the non-AP MLD, one or more null frames to the AP MLD prior to expiration of the maximum idle period.

20. The non-transitory computer readable storage medium of claim 15, wherein the AID Assignment Response frame indicating the request for the second list of AIDs comprises a “no assigned AID” status code indicating that the non-AP MLD has no assigned AIDs.

21. The non-transitory computer readable storage medium of claim 15, the operations further comprising receiving from the AP MLD the second list of AIDs.
